(19) United States
(12) Patent Application Publication
(10) Pub. No.: US 2025/0197653 A1
(43) Pub. Date: Jun. 19, 2025

(54) MODULATING OBJECT SIGNATURES THROUGH THE USE OF PHOTOSENSTIVE SORBENT COATINGS

(71) Applicant: Genesis Systems LLC, Tampa, FL (US)

(72) Inventors: Kurt Francis, Yuma, AZ (US); Owen Erickson, Largo, FL (US); David Stuckenberg, Tampa, FL (US)

(21) Appl. No.: 18/538,696

(22) Filed: Dec. 13, 2023

(51) Int. Cl. C09D 5/26; C09B 57/00; C09D 7/63; C09K 9/02; F41H 3/00

(52) U.S. Cl. CPC C09D 5/26; C09B 57/00; C09D 7/63; C09K 9/02; F41H 3/00; C09K 2211/1007; C09K 2211/188

(57) ABSTRACT

A coating comprising a photosensitive sorbent composition is configured to be able to modulate the spectral signature of an object. The photosensitive sorbent composition has a stepped Type F-IV isotherm profile and can switch between a porous open phase which absorbs electromagnetic radiation and a less porous closed phase which reflects electromagnetic radiation. The photosensitive material can be converted to the closed phase upon exposure to light of a first wavelength through a photochemical transformation to allow for an object coated in the photosensitive material to be detectable by reflecting electromagnetic radiation. The photosensitive material can be converted from the open phase to the closed phase upon exposure to light of a second wavelength to camouflage an object coated the photosensitive by absorbing electromagnetic radiation.

### BACKGROUND

Detection systems such as radar, sonar, and infrared systems are designed to detect and track objects such as planes, ships, and vehicles.

Radar technology involves the use a transmitter which produces electromagnetic waves in the radio or microwave domain which can be reflected off objects and detected by a receiver to determine the location and speed of the objects. In a similar manner, sonar technology involves emitting sound waves and detecting the reflected echoes and is commonly used for detecting objects underwater. As objects tend to emit more infrared (IR) radiation relative to their temperature, radiation from the infrared spectrum can be detected for thermal imaging. Any object or surface will have a characteristic spectral signature based on reflectance or emittance of electromagnetic radiation as a function of the wavelength. While each of these technologies is characterized by some inherent limitations (e.g., radar and sonar technologies require some portion of the object to be perpendicular to the detection system so that emitted detection waves (such as radar waves or sonar waves) are reflected off the detected object and back to the detection system), current iterations of each technology are sufficiently advanced to enable detection of at least some camouflaged objects.

As the technology of these detection systems is improving, there is a need for new camouflaging technologies for certain objects to avoid detection by various detection systems.

### BRIEF SUMMARY

Various embodiments provide photosensitive coatings comprising photosensitive sorbent compositions comprising a light-responsive porous coordination network (PCN) that switches between an open phase which is porous and a closed phase which is less porous with a stepped isotherm profile. Photosensitive sorbent compositions comprise a metal, a photosensitive ligand of the metal which is reversibly transformable between two different molecular structures according to a photochemical transformation, and a bridging ligand that coordinates two or more metal atoms. The photosensitive sorbent composition is configured to reversibly transform from the open phase to the closed phase upon exposure to light of a first wavelength and transforms from the closed phase to the open phase upon exposure to light of a second wavelength. The open phase of the photosensitive sorbent composition has a greater ability to absorb electromagnetic radiation than the closed phase.

Certain embodiments include a dithienylethene, such as a bis-3-thienylcyclopentene, as the photosensitive ligand incorporated into the backbone of the photosensitive sorbent composition which undergoes a reversible photocyclization reaction between a ring-open structure and a ring-closed structure in response to UV light or visible light exposure. In certain embodiments, the bridging ligand comprises a benzene-1,4-dicarboxylic acid, such as 2,5-diphenylbenzene-1,4-dicarboxylic acid (DPT) or 2,5-di-(4-fluorophenyl)benzene-1,4-dicarboxylate (FDPT). In certain embodiments, the metal is cadmium (Cd).

In certain embodiments, the photosensitive coating is configured to transform from the open phase to the closed phase when illuminated with light having a wavelength between about 100-400 nm. In certain embodiments, the photosensitive coating is configured to transform from the closed phase to the open phase when illuminated with light having a wavelength between about 400-800 nm.

In certain embodiments, the open phase of the photosensitive coating is characterized by a first color and the closed phase of the photosensitive coating is characterized by a second color different from the first color.

In certain embodiments, the photosensitive coating has different spectral characteristics when in the open phase and the closed phase, such that an object coated with the photosensitive coating has a first spectral signature when the photosensitive coating is in the open phase and has a second spectral signature different from the first spectral signature when the photosensitive coating is in the closed phase. In certain embodiments, the object coated with the photosensitive coating has a first radar signature when the photosensitive coating is in the open phase and has a second radar signature when the photosensitive coating is in the closed phase, and the first radar signature is lower than the second radar signature. In certain embodiments, the object coated with the photosensitive coating has a first infrared signature when the photosensitive coating is in the open phase and has a second infrared signature when the photosensitive coating is in the closed phase, and the first infrared signature is lower than the second infrared signature.

In certain embodiments, the object coated with the photosensitive coating has a first temperature profile when the photosensitive coating is in the open phase and has a second temperature profile different from the first temperature profile when the photosensitive coating is in the closed phase.

In certain embodiments, the photosensitive coating has different acoustic characteristics when in the open phase and the closed phase, such that an object coated with the photosensitive coating has a first acoustic signature when the photosensitive coating is in the open phase and has a second acoustic signature different from the first acoustic signature when the coating is in the closed phase.

Various embodiments include methods of reversibly camouflaging an object comprising coating an object with a photosensitive coating described herein, irradiating light of the first wavelength on the photosensitive coating to transform the photosensitive coating into the closed phase having a first reflectance characteristic, and irradiating light of the second wavelength on the photosensitive coating to transform the photosensitive coating into the open phase having a second reflectance characteristic that reflects a lesser amount of electromagnetic radiation than the first reflectance characteristic. In certain embodiments, the method is performed on ground, underground, in air, in water, underwater, or in space.

Further embodiments include a reversibly camouflaged object comprising the photosensitive coating provided herein. In certain embodiments, the object is a vehicle. In certain embodiments, the vehicle is selected from the group consisting of an aircraft, a drone, a helicopter, a car, a truck, a tank, a hovercraft, a military vehicle, a ship, a boat and a submarine.

Certain embodiments provide a method of validating the authenticity of an object, the method comprising identifying the photosensitive coating disclosed herein, the identification comprising exposing the photosensitive coating to light of the first and/or second wavelength and detecting one or more physical characteristics of the photosensitive coating in the open phase and/or the closed phase.

### BRIEF DESCRIPTION OF THE SEVERAL VIEWS OF THE DRAWINGS

Reference will now be made to the accompanying drawings, which are not necessarily drawn to scale, and wherein:

FIG. 1 shows altered visual and radar spectrum attributes of planes coated in a photosensitive sorbent composition.

FIG. 2A-2B show gas sorption isotherm profiles for different types of sorbents.

FIGS. 3A-3D show the reversible photocyclization of dithienylethene (3A), bis-3-thienylcyclopentene (3B), spirobenzopyran (3C), and fulgide (3D) derivatives.

FIG. 3E shows the trans-cis photoisomerization of an azobenzene. FIG. 3F shows representative examples of dicarboxylate and dipyridine bridging ligands.

FIG. 4 shows the transition of a photosensitive sorbent composition between open and closed phases.

FIG. 5 shows the structural transformations experienced by LMA-1 (top) and LMA-2 (bottom) upon guest exchange and activation in air.

FIG. 6A shows photomicrographs of a crystal of LMA-1γ1 irradiated with UV light (365 nm) and then with white light (532 nm). High pressure CO₂ sorption isotherms are shown for LMA-1γ2 (FIG. 6B) and LMA-2γ2 (FIG. 6D) at 298K. Selected pressures corresponding to in situ CO₂-loaded PXRD patterns are shown for LMA-1γ2 (FIG. 6C) and LMA-2γ2 (FIG. 6E).

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

### Overview

To camouflage an object from detection, those objects are typically painted, colored, or otherwise coated with materials that minimize undesired detection. The surfaces of those objects are provided with a surface finish to cause the object to optically blend into the surrounding environment (e.g., a matte surface finish may minimize the amount of light reflected off of the object, which may minimize the visibility of the object in certain environments. Moreover, the object may be colored depending on its surrounding environment (e.g., in a forest setting, the object may be colored with a pattern of greens, browns, and blacks). Other objects may simply be colored with a dark color (e.g., black) to minimize optical detection at night. For example, carbon-based materials such as carbon blacks, carbon fibers, carbon nanotubes, graphite, and graphene have been commonly used for camouflage applications. However, these materials have rigid absorptive properties (e.g., absorbing light, but reflecting electromagnetic radiation, such as radio waves or microwaves). Therefore, advantageous camouflaging techniques have further included structural changes to certain objects. For example, stealth aircraft, ground vehicles, and/or watercraft have exterior surface contours designed to minimize the amount of electromagnetic waves that are reflected back to detectors. Although stealth technologies are highly effective against many detection systems, they remain at risk of detection by advanced versions of certain electromagnetic-wave based detection technologies.

The embodiments discussed herein are directed to compositions (e.g., materials, coatings, and/or the like) that are capable of absorbing electromagnetic radiation to minimize the amount of electromagnetic radiation that is reflected off of the surface of an object and that can be detected by a detection system. As discussed herein, porous coordinate networks (PCNs; i.e. metal organic frameworks) can adsorb various chemical species and absorb electromagnetic radiation when in an open (porous) phase (also referred to herein as a camouflaged phase). Moreover, these PCNs are configured to transform between the camouflaged phase and a detectable phase (also referred herein as a closed or non-porous phase) upon exposure to a first stimulus (e.g., light of a first wavelength, pressure at a first pressure level, temperature at a first temperature level, and/or the like). This transformation is reversible by exposing the material to a second stimulus (e.g., light of a second wavelength, pressure at a second pressure, temperature at a second temperature level, and/or the like). In the detectable phase, the PCN does not absorb chemical species and it reflects electromagnetic radiation that can be detected by various detection technologies. Moreover, the color of the composition may also change based on whether the material is in the camouflaged phase or the detectable phase.

The photosensitive sorbent compositions disclosed herein are capable of reversibly switching between porous and non-porous phases by irradiation with certain wavelengths of light. Switching between phases allows for the photosensitive sorbent compositions to modulate their physical characteristics between camouflaged or detectable phases. Consequently, an object coated with the photosensitive sorbent composition can be transformed between a camouflaged phase and a detectable phase with different electromagnetic reflectivity. The photosensitive sorbent compositions are different colors depending on whether the photosensitive sorbent composition is in the camouflaged phase or the detectable phase, such that the photosensitive sorbent composition may change color in response to irradiation with certain wavelengths of light used to change the photosensitive sorbent composition between the camouflaged phase and the detectable phase. The spectral signature of an object coated with the photosensitive sorbent composition, characterized by the specific reflectance and emittance with respect to wavelength of electromagnetic radiation, can be changed by transforming the photosensitive sorbent composition between the camouflaged phase and the detectable phase, which could be useful for signature control, identification, and analysis for stealth technology. Thus, vehicles with photosensitive sorbent compositions painted as coatings (e.g., airborne vehicles such as aircraft, drone, or helicopter, ground-based vehicles such as cars, trucks, tanks, hovercrafts, military vehicles, water-based vehicles such as ships, boats, submarines) can transform their spectral signatures and ability to be detected, providing reversible camouflage by exposing the coating of the vehicle to certain wavelengths of light.

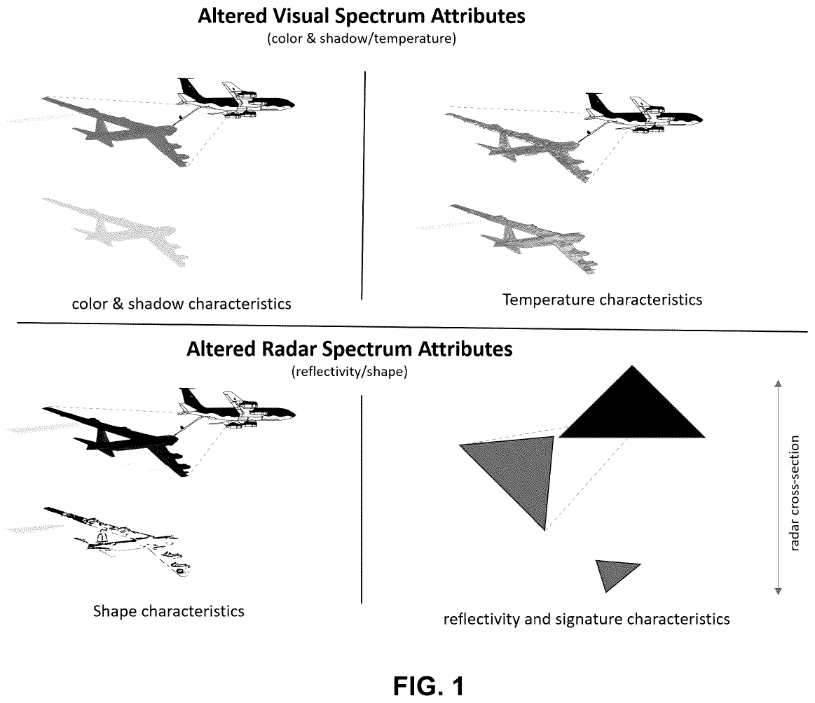

As shown in FIG. 1, various attributes of a plane coated in a photosensitive sorbent composition including color, reflectivity, temperature profile, radar cross section, shadow profile, and signature characteristics can be modulated based on the phase of photosensitive sorbent composition, which can be controlled by irradiation with light of different wavelengths.

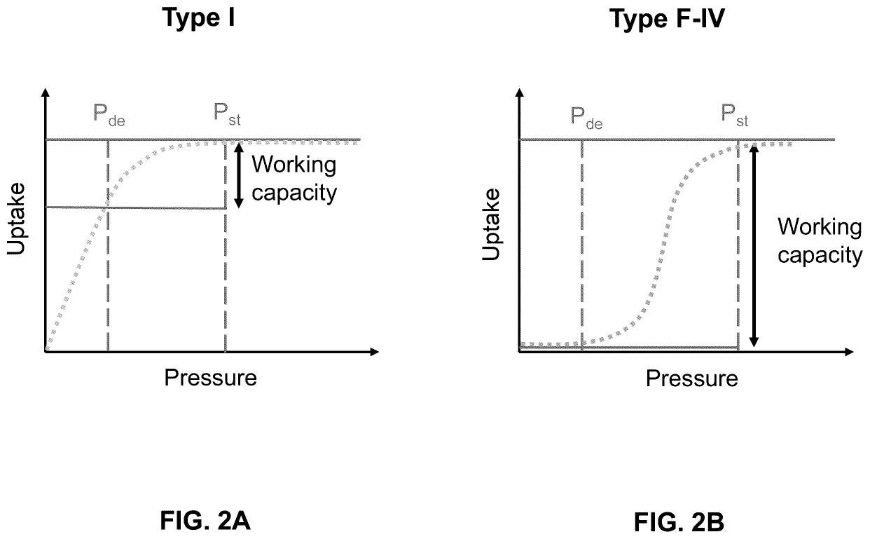

Unlike most rigid PCNs with Type I gas sorption isotherm profiles (FIG. 2A), stimuli-responsive PCNs that switch between closed (non-porous) and open (porous) phases can exhibit what we have termed Type F-IV isotherms (FIG. 2B) which can offer working capacities equal to total uptake if the step occurs between the desired loading and delivery pressures.

Photo-responsive molecules can undergo structural transformations induced by photon absorption (i.e., a molecular switch) and offer potential utility in light modulated adsorbents (LMAs) such as PCNs. However, many LMAs are not stable in both the open and closed phases. One of the open phase or the closed phase is the excited state and the other of the open phase or the closed phase is the ground state of certain LMAs. Those LMAs tend to spontaneously undergo thermal isomerization from the excited state back to their ground states. However, certain materials, including bis-3-thienylcyclopentenes (BTCPs), when irradiated by ultraviolet (UV) light, can undergo photocyclization (concomitant with a color change from colorless to blue) in the solid-state to yield thermally stable ring closed isomers. Cycloreversion (to the ring open form) may be induced by exposure to light of a higher wavelength with previous studies showing relatively high thermal stability and solid-state fatigue resistance of both isomers.

Light-responsive components may be incorporated into PCNs of LMAs and may translate the isomerization of photoactive molecules into changes in the macroscopic properties of the bulk molecular solid.

Strategic crystal engineering design approach to control the switching behavior of LMAs having PCNs are described. The resulting materials discussed herein are photosensitive sorbent compositions comprising organic linkers connected by inorganic nodes and can switch between an open (porous) phase and a closed (non-porous) phase. The photosensitive sorbent compositions exhibit Type F-IV isotherm profiles, which provide desirable properties for sorption applications and have advantages over existing materials, such as those with Type I isotherm profiles. The Type F-IV sorbents have a stepped isotherm profile and exhibit a rapid increase in uptake capacity when the pressure is increased beyond a certain threshold, which provides a larger working capacity as compared to Type I sorbents, which have a limited ability to uptake at operationally useful pressures. The photosensitive sorbent compositions disclosed herein have enhanced kinetics and can cycle between phases at ambient pressure using only light as a stimulus, unlike previously known sorbent materials.

In the camouflaged phase, the photosensitive sorbent material has open pores (i.e., guest sites) that decrease the amount of electromagnetic radiation that is reflected by a surface coated with the photosensitive sorbent material (as compared to an uncoated surface of the same shape). Upon transforming to the closed phase, the photosensitive sorbent material takes on a contracted structure without pores (or with significantly smaller pores) that increase the amount of electromagnetic radiation reflected by the surface (as compared to the photosensitive sorbent material in the camouflaged phase). Thus, a photosensitive sorbent material can be controllably switched between an open/camouflaged phase and a closed/detectable phase.

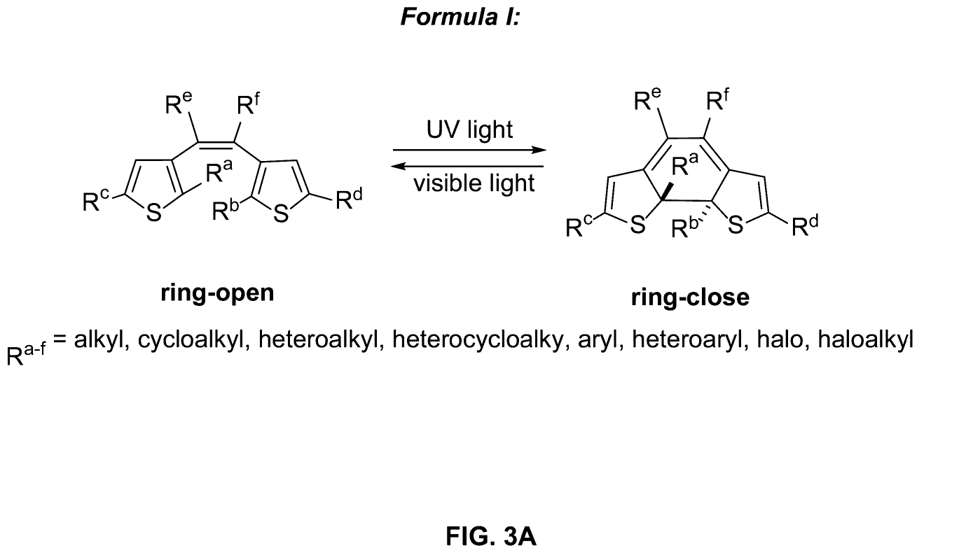

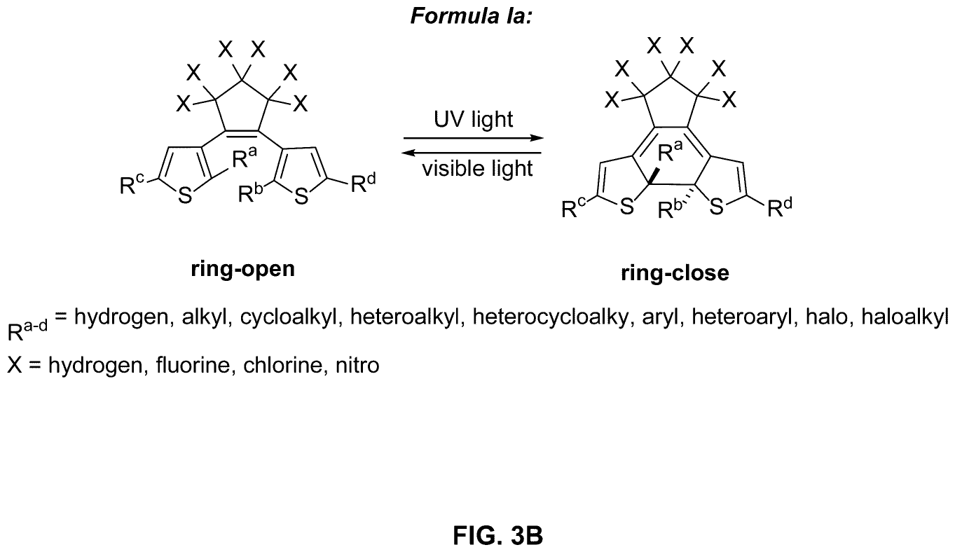

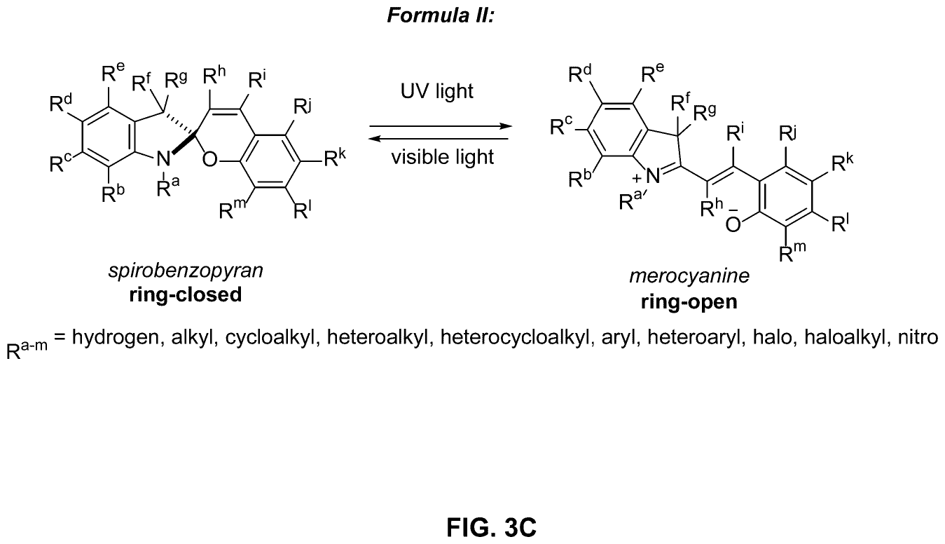

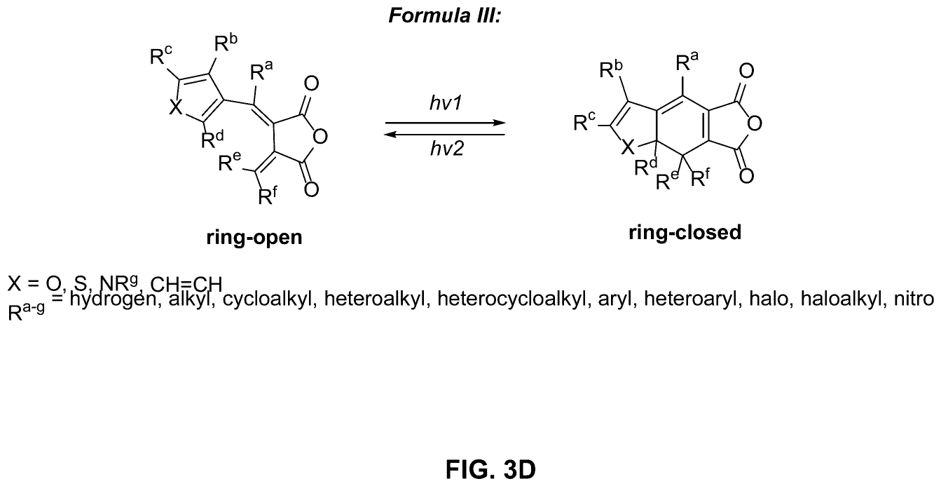

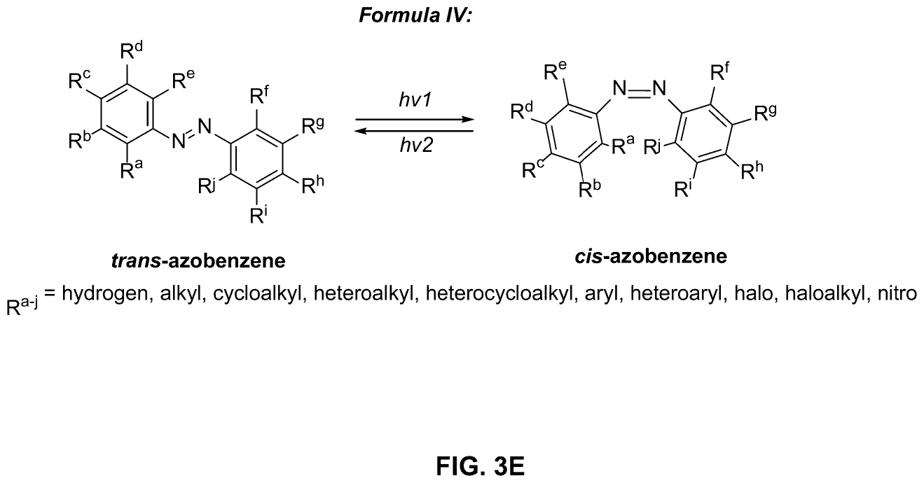

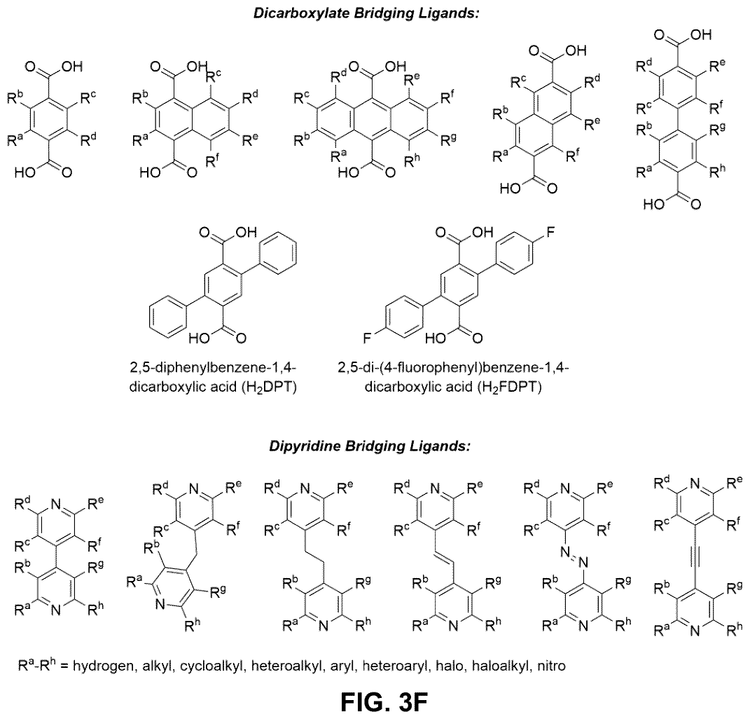

The photosensitive sorbent composition comprises a photosensitive ligand which undergoes a structural transformation induced by photon absorption to act as a molecular switch. In certain embodiments, the photosensitive ligand undergoes a reversible photocyclization reaction and is converted between a ring-open structure (i.e., the camouflaged phase) and a ring-closed structure (i.e., the detectable phase) by exposure to light of a certain wavelength. In certain embodiments, the photosensitive ligand is a dithienylethene derivative (Formula I) which cyclizes from the ring-open structure to the ring-closed structure upon UV light exposure and is converted back to the ring-open structure upon visible light exposure as shown in FIG. 3.

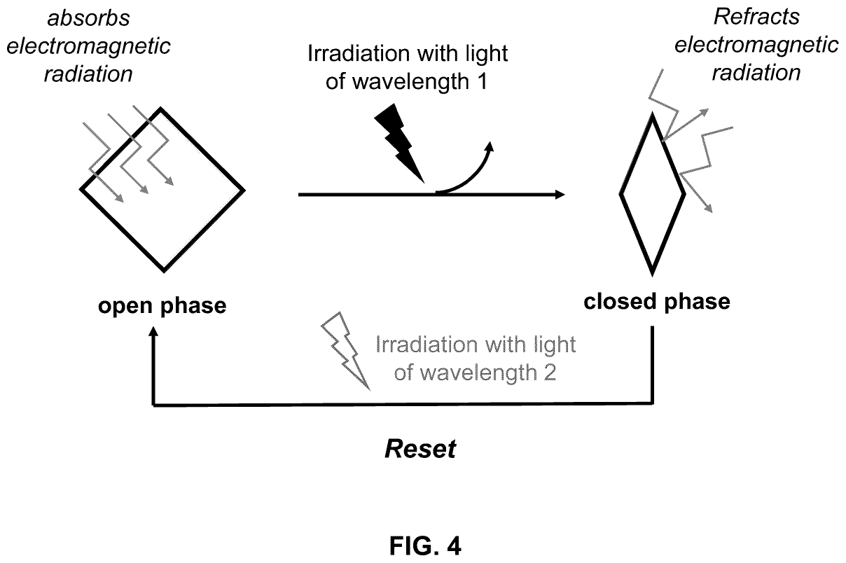

In the camouflaged phase, the photosensitive sorbent composition has open pores capable of absorbing electromagnetic radiation. Upon transforming to the detectable phase, the photosensitive sorbent composition takes on a contracted structure with reduced pore size resulting in more reflectance of electromagnetic radiation. As shown in FIG. 4, a photosensitive sorbent composition can be controllably switched between a camouflage phase to camouflage an object from detection and a detectable phase where the object is more detectable by exposure to light of particular wavelengths.

### Photosensitive Sorbent Compositions

The photosensitive sorbent compositions disclosed herein are materials (e.g., solidified coatings) capable of switching between open/camouflaged (porous) to closed/detectable (non-porous) phases to provide different spectral signatures by modulating the materials' ability to absorb electromagnetic radiation. The photosensitive sorbent compositions comprise a light-responsive PCN with a Type F-IV stepped isotherm profile which rapidly switches from a closed phase (detectable phase) to an open phase (camouflaged phase) with a high working capacity for absorbing electromagnetic radiation by undergoing a structural transformation when exposed to a certain wavelength of light. The structural transformation may be a photocyclization reaction (e.g., ring-opening and ring-closing of a dithienylethene derivative of Formula I).

In certain embodiments, the photosensitive sorbent composition changes color upon undergoing the light-induced structural transformation. In certain embodiments, the photosensitive material is white or colorless when the photosensitive ligand has a ring-opened structure and blue when the photosensitive ligand has the ring-closed structure.

In embodiments, the photosensitive sorbent composition maintains its performance (e.g., ability to absorb electromagnetic radiation) after repeated cycles between the camouflage phase and the detectable phase.

The light-responsive PCN is composed of molecular building blocks which comprise organic linkers connected by inorganic nodes. Each molecular building block of the light-responsive PCN comprising the photosensitive sorbent composition comprises one or more metal atoms, one or more photosensitive ligands, and one or more bridging ligands. In certain embodiments, the metal atom is selected from the group consisting of Ag, Ca, K, Zn, Na, Pb, Mn, Fe, Co, Ni, Al, Si, Cu, Sn, Cd, Hg, Cr, Fe, Bi, Ga, Ge, Au, In, Tl, Rb, Cs, As, Sb, Cr, Zn, V, Pt, Pd, and Rh. In certain embodiments, the metal atom is Cd. In certain embodiments, the photosensitive sorbent composition comprises two or more metals.

The photosensitive ligand coordinates the metal and is incorporated into the backbone of the PCN. The photosensitive ligand undergoes a reversible photochemical transformation between two different molecular structures (e.g., a ring-open structure and a ring-closed structure) upon photon absorption. In certain embodiments, the photosensitive ligand undergoes a photocyclization reaction involving a ring-closing reaction at a first wavelength of light and a ring-opening reaction at a second wavelength of light.

In certain embodiments, the photosensitive ligand is a dithienylethene. In certain embodiments, the dithienylethene has the structure shown in Formula I in FIG. 3A. In certain embodiments, R^{a} and R^{b} are methyl (—CH₃) groups. In certain embodiments, R^{c} and R^{d} are alkyl, cycloalkyl, heteroalkyl, aryl, or heteroaryl groups. In certain embodiments, R^{c} and R^{d} are heteroaryl groups, such as pyridine, quinoline, or isoquinoline. In certain embodiments, R^{c} and R^{d} are 4-pyridyl groups.

In certain embodiments the dithienylethene is a bis-3-thienylcyclopentene and has a structure shown in Formula Ia as shown in FIG. 3B. In certain embodiments, X is hydrogen or a halogen. In certain embodiments, X is fluorine and the bis-3-thienylcyclopentene derivative is a bis-3-thienylperfluorocyclopentene. Bis-3-thienylperfluorocyclopentenes undergo the ring closing reaction shown in Formula Ia when exposed to UV light, optimally of a wavelength of 365 nm and undergo a ring opening when exposed to visible light, optimally of a wavelength of 532 nm. In certain embodiments, the bis-3-thienylperfluorocyclopentene is 1,2-bis[2-methyl-5-(4-pyridyl)-3-thienyl]perfluorocyclopentene (BTCP).

In certain embodiments, the photosensitive ligand comprises a spirobenzopyran which can undergo a ring-opening reaction to form a merocyanine. In certain embodiments, the photosensitive ligand comprises a structure shown in Formula II as shown in FIG. 3C.

In certain embodiments, the photosensitive ligand is a fulgide. In certain embodiments, the fulgide comprises a structure shown in Formula III as shown in FIG. 3D.

In other embodiments, the photosensitive ligand undergoes a photoisomerization reaction, such as a cis-trans isomerization. In certain embodiments, the photosensitive ligand comprises an azobenzene derivative. In certain embodiments, the azobenzene has a structure shown in Formula IV as shown in FIG. 3E.

Each molecular building block of the light-responsive PCN comprises one or more bridging ligands that coordinates to two or more metal atoms. The bridging ligand may coordinate to the metal atom with one or more oxygen atoms or one or more nitrogen atoms. In certain embodiments, each molecular building block of the light-responsive PCN comprises two bridging ligands for each metal atom. In certain embodiments, the bridging ligand is a dicarboxylate and each carboxylate group coordinates one metal atom. In certain embodiments, the bridging ligand is a benzene-1,4-dicarboxylate derivative. In certain embodiments, the bridging ligand is a 2,5-diarylbenzene-1,4-dicarboxylate. In certain embodiments, the bridging ligand is 2,5-diphenylbenzene-1,4-dicarboxylate (DPT). In certain embodiments, the bridging ligand is 2,5-di-(4-fluorophenyl)benzene-1,4-dicarboxylate (FDPT). In other embodiments, the bridging ligand is a diamine. In certain embodiments, the bridging ligand comprises two or more pyridines. In certain embodiments, the bridging ligand has a structure shown in FIG. 3F.

The photosensitive ligands and bridging ligands described above may contain one or more substituents, shown as R groups. The photosensitive sorbent compositions may contain photosensitive ligands and/or bridging ligands with one or more substituents (e.g., R groups) comprising alkyl, cycloalkyl, heteroalkyl, heterocyclyl, haloalkyl, perfluoroalkyl, alkenyl, heteroalkenyl, aryl, heteroaryl, aralkyl, hydroxyl, oxo, carboxyl, thiol, sulfoxide, sulfone, sulfonyl, sulfonamide, amino, amide, nitrile, nitro, azido, and/or halo groups.

When a substituent is specified to be “a bond” the groups that are immediately adjacent to the specified substituent are directly connected to each other in a chemically feasible bonding configuration. All chiral, diastereomeric, racemic forms of a structure are intended, unless a particular stereochemistry or isomeric form is specifically indicated. Compounds described herein can include enriched or resolved optical isomers at any or all asymmetric atoms as are apparent from the depictions, at any degree of enrichment. Both racemic and diastereomeric mixtures, as well as the individual optical isomers can be isolated or synthesized so as to be substantially free of their enantiomeric or diastercomeric partners, and these are all within the scope of the invention.

In general, “substituted” refers to an organic group as defined herein in which one or more bonds to a hydrogen atom contained therein are replaced by one or more bonds to a non-hydrogen atom such as, but not limited to, a halogen (i.e., F, Cl, Br, and I); an oxygen atom in groups such as hydroxyl groups, alkoxy groups, aryloxy groups, aralkyloxy groups, oxo (carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR′, OC(O)N(R′)₂, CN, NO, NO₂, ONO₂, azido, CF₃, OCF₃, R′, O (oxo), S (thiono), C(O), S(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R′)₂, OC(O)N(R′)₂, C(S)N(R′)₂, (CH₂)₀₋₂N(R′)C(O)R′, (CH₂)₀₋₂N(R′)N(R′)₂, N(R′)N(R′)C(O)R′, N(R′)N(R′)C(O)OR′, N(R′)N(R′)CON(R′)₂, N(R′) SO₂R′, N(R′) SO₂N(R′)₂, N(R′)C(O)OR′, N(R′)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR′)R′, or C (═NOR′) R′ wherein R′ can be hydrogen or a carbon-based moiety, and wherein the carbon-based moiety can itself be further substituted.

When a substituent is monovalent, such as, for example, F or Cl, it is bonded to the atom it is substituting by a single bond. When a substituent is more than monovalent, such as O, which is divalent, it can be bonded to the atom it is substituting by more than one bond, i.e., a divalent substituent is bonded by a double bond; for example, a C substituted with O forms a carbonyl group, C—O, which can also be written as “CO”, “C(O)”, or “C(═O)”, wherein the C and the O are double bonded. When a carbon atom is substituted with a double-bonded oxygen (═O) group, the oxygen substituent is termed an “oxo” group. When a divalent substituent such as NR is double-bonded to a carbon atom, the resulting C(═NR) group is termed an “imino” group. When a divalent substituent such as S is double-bonded to a carbon atom, the results C(═S) group is termed a “thiocarbonyl” group.

Alternatively, a divalent substituent such as O, S, C(O), S(O), or S(O)₂ can be connected by two single bonds to two different carbon atoms. For example, O, a divalent substituent, can be bonded to each of two adjacent carbon atoms to provide an epoxide group, or the O can form a bridging ether group, termed an “oxy” group, between adjacent or non-adjacent carbon atoms, for example bridging the 1, 4-carbons of a cyclohexyl group to form a [2.2.1]-oxabicyclo system. Further, any substituent can be bonded to a carbon or other atom by a linker, such as (CH₂) n or (CR′₂), wherein n is 1, 2, 3, or more, and each R′ is independently selected.

C(O) and S(O)₂ groups can be bound to one or two heteroatoms, such as nitrogen, rather than to a carbon atom. For example, when a C(O) group is bound to one carbon and one nitrogen atom, the resulting group is called an “amide” or “carboxamide.” When a C(O) group is bound to two nitrogen atoms, the functional group is termed a urea. When a S(O)₂ group is bound to one carbon and one nitrogen atom, the resulting unit is termed a “sulfonamide.” When a S(O)₂ group is bound to two nitrogen atoms, the resulting unit is termed a “sulfamate.”

Substituted alkyl, alkenyl, alkynyl, cycloalkyl, and cycloalkenyl groups as well as other substituted groups also include groups in which one or more bonds to a hydrogen atom are replaced by one or more bonds, including double or triple bonds, to a carbon atom, or to a heteroatom such as, but not limited to, oxygen in carbonyl (oxo), carboxyl, ester, amide, imide, urethane, and urea groups; and nitrogen in imines, hydroxyimines, oximes, hydrazones, amidines, guanidines, and nitriles.

Substituted ring groups such as substituted cycloalkyl, aryl, heterocyclyl and heteroaryl groups also include rings and fused ring systems in which a bond to a hydrogen atom is replaced with a bond to a carbon atom. Therefore, substituted cycloalkyl, aryl, heterocyclyl and heteroaryl groups can also be substituted with alkyl, alkenyl, and alkynyl groups as defined herein.

By a “ring system” as the term is used herein is meant a moiety comprising one, two, three or more rings, which can be substituted with non-ring groups or with other ring systems, or both, which can be fully saturated, partially unsaturated, fully unsaturated, or aromatic, and when the ring system includes more than a single ring, the rings can be fused, bridging, or spirocyclic. By “spirocyclic” is meant the class of structures wherein two rings are fused at a single tetrahedral carbon atom, as is well known in the art.

As to any of the groups described herein, which contain one or more substituents, it is understood, of course, that such groups do not contain any substitution or substitution patterns which are sterically impractical and/or synthetically non-feasible. In addition, the compounds of this disclosed subject matter include all stereochemical isomers arising from the substitution of these compounds. Selected substituents within the compounds described herein may be present to a recursive degree. In this context, “recursive substituent” means that a substituent may recite another instance of itself or of another substituent that itself recites the first substituent.

Alkyl groups include straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2, 2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed above, for example, amino, hydroxy, cyano, carboxy, nitro, thio, alkoxy, and halogen groups.

The term “alkylene” means a linear saturated divalent hydrocarbon radical of one to six carbon atoms or a branched saturated divalent hydrocarbon radical of one to six carbon atoms unless otherwise stated, such as methylene, ethylene, propylene, 1-methylpropylene, 2-methylpropylene, butylene, pentylene, and the like.

The term “carbonyl” means C═O.

The terms “carboxy” and “hydroxycarbonyl” mean COOH.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups can be mono-substituted or substituted more than once, such as, but not limited to, 2,2-, 2,3-, 2,4-, 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

Alkenyl groups include straight and branched chain and cyclic alkyl groups as defined above, except that at least one double bond exists between two carbon atoms. Thus, alkenyl groups have from 2 to about 20 carbon atoms, and typically from 2 to 12 carbons or, in some embodiments, from 2 to 8 carbon atoms.

Alkynyl groups include straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8 carbon atoms.

The term “heteroalkyl” by itself or in combination with another term means, unless otherwise stated, a stable straight or branched chain alkyl group consisting of the stated number of carbon atoms and one or two heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkyl group, including between the rest of the heteroalkyl group and the fragment to which it is attached, as well as attached to the most distal carbon atom in the heteroalkyl group.

A “heterocycloalkyl” ring is a cycloalkyl ring containing at least one heteroatom. A heterocycloalkyl ring can also be termed a “heterocyclyl,” described below.

The term “heteroalkenyl” by itself or in combination with another term means, unless otherwise stated, a stable straight or branched chain monounsaturated or di-unsaturated hydrocarbon group consisting of the stated number of carbon atoms and one or two heteroatoms selected from the group consisting of O, N, and S, and wherein the nitrogen and sulfur atoms may optionally be oxidized and the nitrogen heteroatom may optionally be quaternized.

Aryl groups are cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined above. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed above.

Aralkyl groups are alkyl groups as defined above in which a hydrogen or carbon bond of an alkyl group is replaced with a bond to an aryl group as defined above. Representative aralkyl groups include benzyl and phenylethyl groups and fused (cycloalkylaryl) alkyl groups such as 4-ethyl-indanyl. Aralkenyl group are alkenyl groups as defined above in which a hydrogen or carbon bond of an alkyl group is replaced with a bond to an aryl group as defined above.

Heterocyclyl groups or the term “heterocyclyl” includes aromatic and non-aromatic ring compounds containing 3 or more ring members, of which, one or more is a heteroatom such as, but not limited to, N, O, and S. Thus, a heterocyclyl can be a heterocycloalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise, a C₄-heterocyclyl can be a 5-ring with one heteroatom, a 6-ring with two heteroatoms, and so forth. The number of carbon atoms plus the number of heteroatoms sums up to equal the total number of ring atoms. A heterocyclyl ring can also include one or more double bonds. A heteroaryl ring is an embodiment of a heterocyclyl group. The phrase “heterocyclyl group” includes fused ring species including those comprising fused aromatic and non-aromatic groups. For example, a dioxolanyl ring and a benzdioxolanyl ring system (methylenedioxyphenyl ring system) are both heterocyclyl groups within the meaning herein. The phrase also includes polycyclic ring systems containing a heteroatom such as, but not limited to, quinuclidyl. Heterocyclyl groups can be unsubstituted or can be substituted as discussed above. Heterocyclyl groups include, but are not limited to, pyrrolidinyl, piperidinyl, piperazinyl, morpholinyl, pyrrolyl, pyrazolyl, triazolyl, tetrazolyl, oxazolyl, isoxazolyl, thiazolyl, pyridinyl, thiophenyl, benzothiophenyl, benzofuranyl, dihydrobenzofuranyl, indolyl, dihydroindolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Representative substituted heterocyclyl groups can be mono-substituted or substituted more than once, such as, but not limited to, piperidinyl or quinolinyl groups, which are 2-, 3-, 4-, 5-, or 6-substituted, or disubstituted with groups such as those listed above.

Heteroaryl groups are aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth. Likewise, a C₄-heteroaryl can be a 5-ring with one heteroatom, a 6-ring with two heteroatoms, and so forth. The number of carbon atoms plus the number of heteroatoms sums up to equal the total number of ring atoms. Heteroaryl groups include, but are not limited to, groups such as pyrrolyl, pyrazolyl, triazolyl, tetrazolyl, oxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted or can be substituted with groups as is discussed above. Representative substituted heteroaryl groups can be substituted one or more times with groups such as those listed above.

Additional examples of aryl and heteroaryl groups include but are not limited to indenyl, furylxanthenyl, isoindanyl, acridinyl, imidazolyl, triazolyl, oxazolyl pyridyl (2-pyridyl, 3-pyridyl, 4-pyridyl), pyrimidinyl (2-pyrimidinyl, 4-pyrimidinyl, 5-pyrimidinyl, 6-pyrimidinyl), pyrazinyl, pyridazinyl, quinolyl (2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]thiophenyl, indazole, carbazolyl and the like.

Heterocyclylalkyl groups are alkyl groups as defined above in which a hydrogen or carbon bond of an alkyl group as defined above is replaced with a bond to a heterocyclyl group as defined above. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

Heteroarylalkyl groups are alkyl groups as defined above in which a hydrogen or carbon bond of an alkyl group is replaced with a bond to a heteroaryl group as defined above.

The term “alkoxy” refers to an oxygen atom connected to an alkyl group, including a cycloalkyl group, as are defined above. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like.

The terms “halo” or “halogen” or “halide” by themselves or as part of another substituent mean, unless otherwise stated, a fluorine, chlorine, bromine, or iodine atom, preferably, fluorine, chlorine, or bromine.

A “haloalkyl” group includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1, 2-dichloroethyl, 1,3-dibromo-3, 3-difluoropropyl, perfluorobutyl, and the like.

The term “perfluoroalkyl” means an alkyl, alkenyl, cycloalkyl or cycloalkenyl group wherein all hydrogen atoms are replaced by fluorine atoms.

The terms “aryloxy” and “arylalkoxy” refer to, respectively, an aryl group bonded to an oxygen atom and an aralkyl group bonded to the oxygen atom at the alkyl moiety. Examples include but are not limited to phenoxy, naphthyloxy, and benzyloxy.

The term “amine” includes primary, secondary, and tertiary amines having, e.g., the formula N (group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like.

An “amino” group is a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The term “amide” (or “amido”) includes C- and N-amide groups, i.e., —C(O)NR₂, and —NRC(O)R groups, respectively. Amide groups therefore include but are not limited to primary carboxamide groups (—C(O)NH₂) and formamide groups (—NHC(O)H). A “carboxamido” or “aminocarbonyl” group is a group of the formula C(O)NR₂, wherein R can be H, alkyl, aryl, etc.

The term “azido” refers to an N₃ group. An “azide” can be an organic azide. The term “nitro” refers to an NO₂ group bonded to an organic moiety.

The term “urethane” (“carbamoyl” or “carbamyl”) includes N- and O-urethane groups, i.e., —NRC(O)OR and —OC(O)NR₂ groups, respectively.

The term “sulfonamide” (or “sulfonamido”) includes S- and N-sulfonamide groups, i.e., —SO₂NR₂ and —NRSO₂R groups, respectively. Sulfonamide groups therefore include but are not limited to sulfamoyl groups (—SO₂NH₂).

The term “amidine” or “amidino” includes groups of the formula —C(NR)NR₂. Typically, an amidino group is —C(NH)NH₂.

The term “guanidine” or “guanidino” includes groups of the formula —NRC(NR)NR₂. Typically, a guanidino group is —NHC(NH)NH₂.

If a value of a variable that is necessarily an integer, e.g., the number of carbon atoms in an alkyl group or the number of substituents on a ring, is described as a range, e.g., 0-4, what is meant is that the value can be any integer between 0 and 4 inclusive, i.e., 0, 1, 2, 3, or 4.

### Photosensitive Sorbent Coatings

Various embodiments are directed to coatings comprising the photosensitive sorbent compositions disclosed herein for deposition on a solid object. The photosensitive coatings are applied on an object for which it would be useful to be able to modulate the spectral signature and detectability (e.g., an aircraft, an automobile, a tank, a ship, a submarine, or a missile). The photosensitive coating may be deposited onto the object by painting, spraying, dipping, spreading, and/or other appropriate methods and allowing the coating to cure and harden.

The photosensitive coating may comprise additional pigment and/or paint materials with the photosensitive sorbent composition. The additional pigment may be included for optimal camouflaging characteristics. The additional paint materials may include but are not limited to binders, resins, solvents, wetting agents, anti-settling agents, curing agents, and stabilizers.

In various embodiments, the photosensitive sorbent composition can guide, manipulate or capture electromagnetic waves, including invisible waves such as K, X, and other radar bands and waves in the visible spectrum. Detection methods using radar in the X band range (i.e., 8.0-12.5 GHz frequency and wavelength of 3.75-2.4 cm) are used to track and measure objects including body shape, surface details, materials and antennas.

In certain embodiments, the specific composition of the photosensitive coating including the photosensitive sorbent composition and/or other components is provided to enable the photosensitive coating to reversibly transform between the camouflaged phase and detectable phase. In certain embodiments, the photosensitive coating has different spectral signatures in the camouflaged phase and the detectable phase. For example, the photosensitive coating may have a different spectral signature in the camouflaged phase and the detectable phase for one or more wavelengths of electromagnetic radiation, such as radio waves, microwaves, infrared waves, visible light, ultraviolet radiation, X-rays, and gamma rays. While the photosensitive coating on an object is in the camouflaged phase, the object may be camouflaged from radar detection systems at least in part because the photosensitive coating on the object absorbs electromagnetic radiation in the radio and/or microwave domain that would otherwise be reflected back to the radar detection systems. In certain embodiments, the photosensitive coating absorbs and/or reduces the reflectance of radio waves (i.e., frequency of about 3 Hz-1 GHz and wavelength of 300 cm-100,000 km) off of a surface coated with the photosensitive coating in the camouflaged phase. Radio waves can be extremely low frequency (ELF; 3-30 Hz), super low frequency (SLF; 30-300 Hz), ultra low frequency (ULF; 300-3000 Hz), very low frequency (VLF; 3-30 kHz), low frequency (LF; 30-300 kHz), medium frequency (MF; 300-3000 kHz), high frequency (HF; 3-30 MHZ), very high frequency (VHF; 30-300 MHZ), ultra high frequency (UHF; 300-1000 MHz); L band (1-2 GHZ); S band (2-4 GHZ), C band (4-8 GHZ), X band (8-12 GHz), Kᵤ band (12-18 GHZ), K band (18-27 GHZ), Kₐ band (27-40 GHZ), V band (40-75 GHZ), and W band (75-110 GHZ).

In certain embodiments, the photosensitive coating absorbs and/or reduces the reflectance of microwaves (i.e., frequency of about 1-300 GHz and wavelength of 1 mm-30 cm) off of a surface coated with the photosensitive coating in the camouflaged phase. In certain embodiments, the photosensitive coating absorbs and/or reduces the reflectance of infrared waves (i.e., frequency of about 300 GHZ-430 THz and wavelength of 700 nm-1 mm) off of a surface coated with the photosensitive coating in the camouflaged phase. In certain embodiments, the photosensitive coating absorbs and/or reduces the reflectance of visible waves (i.e., frequency of about 430 THz-750 GHz and wavelength of 400-700 nm) off of a surface coated with the photosensitive coating in the camouflaged phase. In certain embodiments, the photosensitive coating absorbs and/or reduces the reflectance of ultraviolet waves (i.e., frequency of about 750 THz-30 PHz and wavelength of 10-400 nm) off of a surface coated with the photosensitive coating in the camouflaged phase.

In certain embodiments, the photosensitive coating modulates visual signatures such as color and or shadow profiles of an object coated with the photosensitive coating, depending on whether the photosensitive coating is in the camouflaged phase or the detectable phase. In certain embodiments, the open phase (camouflaged phase) of the photosensitive coating is characterized by a first color and the closed phase (detectable phase) of the photosensitive coating is characterized by a second color different from the first color. In one embodiment, the photosensitive coating is blue when in the closed phase. In certain embodiments, an object coated with the photosensitive coating has a first shadow profile when the photosensitive coating is in the open phase (camouflaged phase) and has a second shadow profile different from the first shadow profile when the coating is in the closed phase (detectable phase). In certain embodiments, the object coated with the photosensitive coating has a reduced shadow profile when the photosensitive coating is in the open phase as compared with a shadow profile of the object when the photosensitive coating is in the closed phase.

In certain embodiments, the photosensitive coating modulates acoustic signatures of an object coated with the photosensitive coating by absorbing, impeding, and/or dampening sound waves to reduce detectability by sonar when the photosensitive coating is in the camouflaged phase. In certain embodiments, the photosensitive coating has different acoustic characteristics when in the camouflaged phase and the detectable phase, such that an object coated with the photosensitive coating has a first acoustic signature when the photosensitive coating is in the camouflaged phase and has a second acoustic signature different from the first acoustic signature when the coating is in the detectable phase. In certain embodiments, the photosensitive coating absorbs, impedes, and/or dampens sound waves to a greater extend when in the camouflaged phase than the detectable phase.

In certain embodiments, the photosensitive coating modulates a drag profile of an object coated in a photosensitive sorbent material as it moves through air or water depending on whether the photosensitive coating is in the camouflaged phase or the detectable phase. In certain embodiments, an object coated with the photosensitive coating has a first drag profile when the photosensitive coating is in the camouflaged phase (open phase) and has a second drag profile different from the first drag profile when the coating is in the detectable phase (closed phase). In certain embodiments, an object coated with the photosensitive coating has less drag when the photosensitive material is in camouflaged phase than when the photosensitive material is in the detectable phase (closed phase).

In certain embodiments, the photosensitive coating is configured to expand or contract as it transforms between the camouflaged phase and the detectable phase. For example, the photosensitive coating has a first thickness when the photosensitive coating is in the camouflaged phase and a second thickness different from the first thickness when the photosensitive coating is in the detectable phase.

The physical characteristics of the photosensitive coating are tunable by controlling the phase of the photosensitive sorbent composition. In certain embodiments, the physical characteristics of the photosensitive coating switch rapidly between two states (e.g., on/off camouflage). In other embodiments, the physical characteristics of the photosensitive coating are dynamic and may gradually change (e.g., from ambient light exposure).

Certain embodiments include objects coated in the photosensitive coatings described herein. A reversibly camouflaged object may be a vehicle coated in the photosensitive coating. In certain embodiments, the vehicle is selected from the group consisting of an aircraft, a drone, a helicopter, a car, a truck, a tank, a hovercraft, a military vehicle, a ship, a boat, and a submarine. In other embodiments, the reversibly camouflaged object is a covering for a stationary object or person (e.g., camouflage clothing). In certain embodiments, the photosensitive coating is deposited as a layer on the object (e.g., painted, sprayed, or otherwise applied on top of the object). In certain embodiments, the photosensitive coating involves incorporating the photosensitive sorbent composition into a component of the object. For example, the photosensitive sorbent composition may be mixed into a material such as a plastic used to form the object.

In certain embodiments, the entirety of the object is coated in the photosensitive coating. In other embodiments, a portion of the object is coated in the photosensitive coating. In certain embodiments, the photosensitive coating is applied in a pattern on portions of the object. Partially coating an object in the photosensitive material may confuse enemy detection methods and provide distraction.

### Methods for Modulating Detection of an Object

In embodiments, an object coated in a photosensitive coating is irradiated with light of a second wavelength to initiate transformation of the photosensitive coating from a detectable phase to a camouflaged phase. The transformation of the photosensitive coating is reversible by irradiating the object with light of a first wavelength to initiate transformation of the photosensitive coating from the camouflaged phase to the detectable phase. While the photosensitive coating is in the open configuration, the coating absorbs certain wavelengths of electromagnetic waves irradiated onto the object. Because the photosensitive coating absorbs those wavelengths of electromagnetic radiation instead of reflecting the radiation, the object is camouflaged from a detection system that monitors the electromagnetic waves to detect objects. As mentioned, the transformation to the camouflaged phase is reversible by irradiating the photosensitive coating with light of a first wavelength to transform the photosensitive coating from camouflaged phase to the detectable phase. While the photosensitive coating is in the closed configuration, the coating reflects the wavelengths of electromagnetic radiation that were previously absorbed while the coating was in the camouflaged phase. Because the photosensitive coating reflects those wavelengths of electromagnetic radiation, the object is detectable by detection systems that monitor the electromagnetic waves to detect objects. In certain embodiments, the light of a second wavelength has a higher wavelength than the light of a first wavelength.

In certain embodiments, the light of the first wavelength is UV light. In certain embodiments, the light of the first wavelength is emitted by a lighting device. The lighting device may an LED lighting device, an OLED lighting device, a flexible lighting device, and/or the like. In certain embodiments, the light of the first wavelength is natural light. In some embodiments, the light of the first wavelength is natural light directed through a long-pass filter or a bandpass filter that removes shorter-wavelength light from the natural light. In some embodiments, the lighting device is a separate device that may be placed proximate the object coated with the photosensitive coating to irradiate the object with light of the first wavelength. In other embodiments, the object may contain the lighting device, such that the light of the first wavelength is emitted from within the object (e.g., through an outer surface of the object to irradiate a back surface of the photosensitive coating that is adhered to the outer surface of the object. In some embodiments, the lighting device may be configured to adjust the wavelength of emitted light between the first wavelength and a second wavelength (used for reversing the transformation of the photosensitive coating to the camouflaged phase). In other embodiments, the lighting device is configured to emit only light of the first wavelength and a separate, second lighting device is used to emit light of the second wavelength to irradiate the object with light of the second wavelength.

In some embodiments, the light of the first wavelength is between 100-400 nm, between 200-400 nm, between 300-400 nm, between 350-400 nm, between 350-375 nm, or between 360-370 nm. In certain embodiments, the light of the second wavelength is visible light. In certain embodiments, the light of the second wavelength emitted by the lighting device is between 400-800 nm, between 400-700 nm, between 400-600 nm, between 500-600 nm, between 500-550 nm, or between 525-540 nm.

In certain embodiments, the lighting device applies light of a first wavelength and/or light of a second wavelength to the reversibly camouflaged object coated in the photosensitive coating to modulate the detectable physical characteristics of the object. In certain embodiments, the lighting device is disposed in/on a vehicle which is movable near the reversibly camouflaged object and is configured to irradiate light (e.g., light of the first wavelength and/or light of the second wavelength) on the object. For example, an airborne asset that is coated in the photosensitive coating may be in the closed phased as it is refueling on the ground with a detectable radar signature and color. The airborne asset can later take off (e.g., for a sortie) and a drone having a lighting device thereon irradiates light of 532 nm on the photosensitive coating of the airborne asset to transform the photosensitive coating to an open phase (camouflaged phase) which absorbs electromagnetic radiation that may be emitted by radar systems. The airborne asset is consequently provided with a different spectral signature and detectable physical characteristics, such as color, reduced radar cross section and temperature profile. Later, light of 365 nm can be irradiated on the airborne asset (e.g., by the drone or another vehicle having a light source thereon) to convert the photosensitive coating back to the closed phase (detectable phase) to return the original spectral signature and physical characteristics. For example, the airborne asset may be returned to the detectable phase prior to landing or after landing.

A device for initiating a transformation of the photosensitive coating may comprise one or more light sources. The device may be a stationary object (e.g., light source at an airplane hangar or refueling station) or the device may be disposed in/on a vehicle comprising the device. In certain embodiments, the device comprises two different lighting devices each comprising one or more light sources. The light sources of a first lighting device of the two lighting devices emit light having a first wavelength and the light sources of a second lighting device of the two lighting devices emit light having a second wavelength. In other embodiments, the device comprises one lighting device comprising one or more light sources that are configurable between two or more modes to emit light of different wavelengths, including light of the first wavelength and light of the second wavelength. In certain embodiments, the light sources may be LEDs, OLEDs, florescent bulbs, incandescent bulbs, natural (ambient) light, and/or the like. In certain embodiments, one or more light sources emit light of a single wavelength. In other embodiments, one or more light sources emit light within a range of wavelengths. In certain embodiments, one or more light sources use a filter to remove undesired wavelengths of light. In at least some embodiments where one or more light sources emit light with a range of wavelengths, the range of wavelengths of light emitted for the switch from open phase (camouflaged phase) to closed phase (detectable phase) do not overlap with the range of wavelengths of light emitted for the switch from closed phase to open phase.

In certain embodiments, the light source (e.g., LED) is applied to the backing of the photosensitive sorbent material to deliver light at the interface of the photosensitive sorbent material and the object coated in the photosensitive coating. In certain embodiments the photosensitive coating is applied on a transparent substrate on the object (e.g., clear glass, clear plastic, or polymer film). In certain embodiments, the light source (e.g., LED) is positioned within the object (e.g., underneath the transparent substrate or embedded into the transparent substrate). In certain embodiments, the light source has two modes and is switched between a first wavelength and a second wavelength for reversible camouflage.

The transformation of the reversibly camouflaged object between the open and closed phase can occur on the ground, underground, in the air, in water, underwater, or in the vacuum of space to change the spectral signature and physical characteristics of the object. The transformation of the reversibly camouflaged object between the open and closed phase can change the spectral signature, radar signature, infrared signature, temperature profile, color, acoustic signature, shadow profile, and/or drag profile of the object.

Certain embodiments are directed to a method of validating the authenticity of an object that is at least partially coated with the photosensitive coating. In certain embodiments, the method comprises identifying the photosensitive coating by exposing the photosensitive coating to light of the first and/or second wavelength and detecting one or more physical characteristics (e.g., radar signature, infrared signature, temperature profile, color, etc.) of the photosensitive coating in the camouflaged phase and/or the detectable phase. In certain embodiments the device for initiating a transformation described herein or a similar device is used to validate the authenticity of a reversibly camouflaged object together with a detection device (e.g., a radar detection device, an infrared detection device, and/or the like).

### Manufacturing Photosensitive Coatings

In embodiments, photosensitive coatings are manufactured with the photosensitive sorbent compositions described herein. The photosensitive ligands and bridging ligands may be synthesized by any method known in the art. In embodiments where the photosensitive ligand is BTCP, the ligand may be synthesized as described in Nikolayenko, V. I., Castell, D. C., van Heerden, D., Barbour, L. J., Angew. Chem. Int. Ed. 2018, 57, 12086-12091. The photosensitive sorbent composition may be synthesized by a solvothermal reaction of a metal salt with the photosensitive ligand and the bridging ligand in an appropriate solvent. The solvent may contain an alcohol (e.g., methanol, ethanol, isopropanol) and/or a polar aprotic solvent (e.g., DMF, DMSO, THF, DCM). The metal salt may be a halide or nitrate (e.g., Cd(NO₃)₂) and/or a hydrate.

The photosensitive coating may be manufactured by combining the photosensitive sorbent composition with one or more pigments and/or paint materials. The additional paint materials may include but are not limited to binders, resins, solvents, wetting agents, anti-settling agents, curing agents, and stabilizers. For example, a carrier solution for depositing the photosensitive coating on an object may include urethanes, polyurethanes, acrylics, polyacrylate, sodium polyacrylate, and polyamides.

### Examples

Large colorless hexagonal crystals of [Cd(BTCP)-(DPT)₂·3DMF], LMA-1-α, and [Cd(BTCP)(FDPT)₂·3DMF], LMA-2-α, (H₂DPT=2,5-diphenylbenzene-1,4-dicarboxylic acid, H₂FDPT=2,5-di-(4-fluorophenyl)benzene-1,4-dicarboxylic acid BTCP=1,2 bis[2-methyl-5-(4-pyridyl)-3-thienyl]perfluorocyclopentene) were obtained through solvothermal reaction of Cd(NO₃)₂·4H₂O with BTCP and either H₂DPT or H₂FDPT in a solution of ethanol and N,Ndimethylformamide (DMF).

Single crystal X-ray diffraction (SCXRD) analysis revealed that LMA-1-α and LMA-2-α are isostructural, both having crystallized in the space group P21/c with one cadmium cation, two half DPT (or two half FDPT) ligands, one BTCP ligand and three DMF guest molecules per asymmetric unit (ASU). Each cadmium molecular building block (MBB) extends to form a 3D non-interpenetrated network with 8-c hex topology.

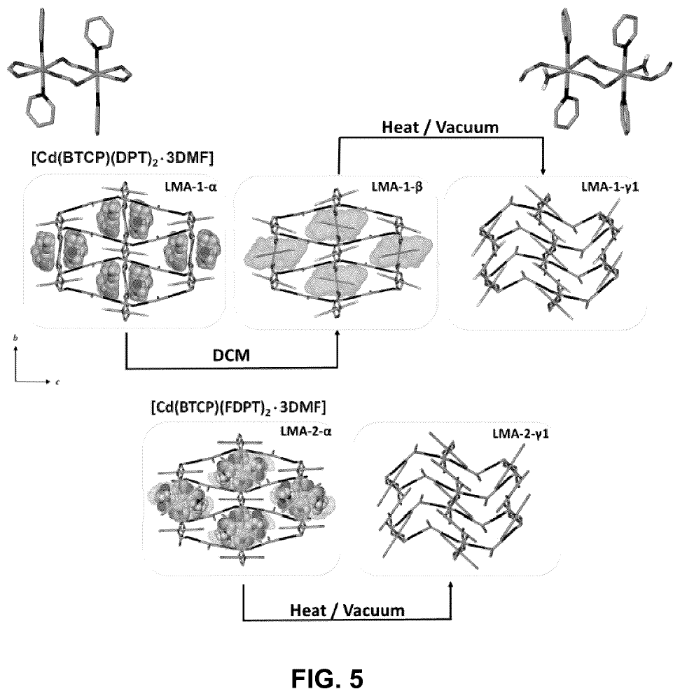

As shown in FIG. 5, in LMA-1-α, DMF occupied channels account for 27% of unit cell volume (determined using a Connolly map with a 1.5 Å probe radius) and are separated by the presence of DPT ligands rotated into the a-axis while DPT ligands located at the apex of each channel are oriented along the c-axis. The channels in LMA-2-α account for 32% of unit cell volume and, unlike in LMA-1-α, the FDPT ligands orient diagonally to the a-axis connecting two channels into one at regular intervals. The FDPT ligands at the apex of each channel remain oriented along the c-axis. The distances between the two photoactive carbon atoms in LMA-1-α and LMA-2-α are 3.708(9) and 3.621(4) Å, respectively.

When crystals of LMA-1-α were soaked in dichloromethane (DCM), they underwent rapid striation and SCXRD analysis revealed the formation of a new phase (LMA-1-β) with the space group unchanged but with the b-axis reduced by 1.2 Å and the unit cell volume by 11%. This transformation can be ascribed to rotation of the DPT ligand, which was previously oriented into the a-axis and now points diagonally along the c-axis, dividing the corrugated channels into isolated cavities that account for 21% of unit cell volume. Although the DCM guest molecules could not be modelled crystallographically, the residual electron density analysis, as implemented by the SQUEEZE routine of PLATON, indicated the presence of two DCM molecules per ASU. The distance between the two photoactive carbon atoms in LMA-1-β remains almost unchanged (3.708(2) Å). Soaking LMA-2-α in DCM induced immediate powdering and thus LMA-2-β was not studied further.

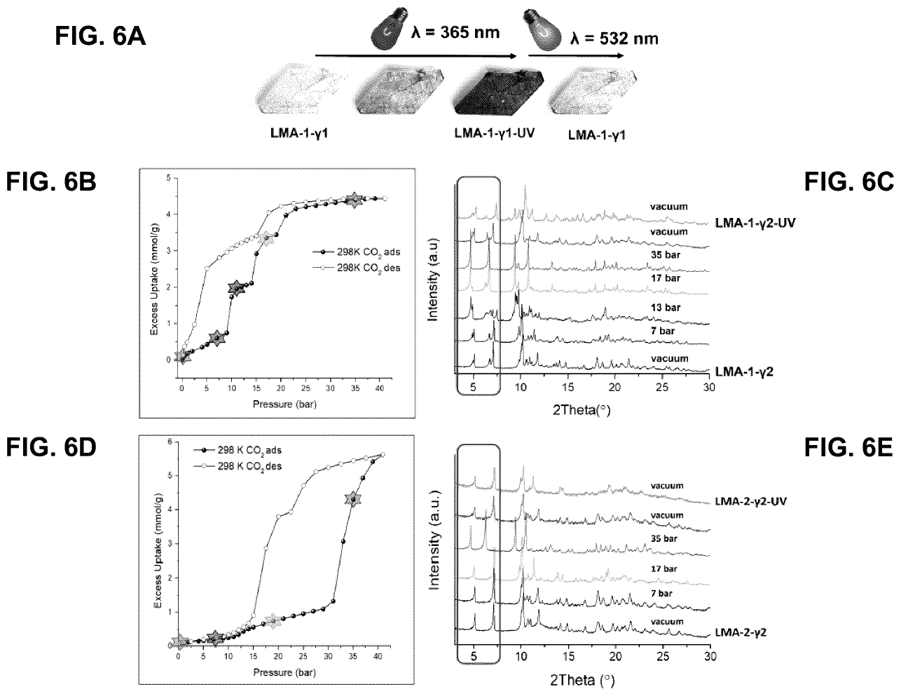

When heat or vacuum was applied to LMA-1-β or LMA-2-α they underwent an additional structural transformation to the non-porous forms LMA-1-γ1 and LMA-2-γ1. Both sorbents were found to be isostructural with further reductions in the b-axis length and unit cell volume. The beta angles increased by 10.2° and 15.42° respectively. This concertina-type contraction resulted from cleaving of one of the previously chelating DPT (or FDPT) ligands to mono-coordinate. In the presence of air, the coordinatively unsaturated metal was found to be occupied by an aqua ligand and, in the case of LMA-1-γ1, one guest water molecule was located. It should be noted that the transformations observed in LMA-2 caused fragmentation of the single crystals. The resulting powder was shown to be microcrystalline by powder X-ray diffraction (PXRD). Another notable feature of these transformations is that the reactive C . . . C distance in LMA-1-γ1 and LMA-2-yl decreased to 3.486(2) and 3.564(4) Å, respectively. This reduction, coupled with the better crystal quality, prompted us to study the effect of ultra-violet (UV) light upon LMA-1-yl. The photomicrographs in FIG. 6A show that upon irradiation with UV light, an initially colorless single crystal of LMA-1-γ1 changed color to dark blue within seconds. This color change can be attributed to the formation of a C—C bond between the two reactive carbon atoms in the BTCP linker. This transformation was found to be reversible with the application of light of a higher wavelength as evidenced by reversion of crystal color from dark blue to colorless. Inspection of the LMA-1-γ1-UV crystal structure revealed that the reactive C . . . C distance is now a C—C bond of 1.701(6) Å. Furthermore, the a- and b-axes exhibited an increase, while the c-axis and beta angle decreased. The structure is non-porous.

PXRD, thermogravimetric analysis (TGA) and Fourier transform Infrared spectroscopy (FTIR) experiments are consistent with SCXRD data. Variable temperature PXRD experiments under nitrogen flow on both LMA-α forms confirmed that these as-synthesized phases can directly transform to guest-free LMA-72 (no coordinated aqua ligands). In both cases, with increased heating (in the temperature range of guest-loss observed in TGA experiments) PXRD peaks were observed to shift to higher 20 values, which is consistent with contraction of the unit cell. The PXRD diffractograms of both sorbents measured at 200° C. show some peak splitting. Without the SCXRD of LMA-γ2 to provide a reference PXRD, the origin of the observed peak splitting and variances between LMA-γ1 and LMA-γ2 cannot be verified. Overall, the PXRDs at 25° C. match well with those obtained for each phase under vacuum. To further investigate the phase behavior of both LMA-γ2 sorbents over a broad P/P₀ range, low temperature 77 K N₂, 195 K CO₂, and 195 K C₂H₂ gas sorption experiments were performed. LMA-1-γ2 underwent a switching (closed to open) phase transition with a threshold pressure of 0.16 bar while no appreciable N₂ uptake was observed for LMA-2-γ2. In the case of CO₂, LMA-1-γ2 underwent a 2-step transformation with a threshold pressure of 0.02 bar while LMA-2-γ2 underwent single-step con-version with an inflection at higher partial pressure (0.07 bar). The recyclability of both materials was investigated using CO₂ at 195 K. After four cycles of adsorption-desorption, no reduced performance (ability to adsorb or desorb compositions and ability to absorb electromagnetic radiation) was observed. The total uptake and effective working capacity (0.1-1 bar) for LMA-1-γ2 is about 114 cc g⁻¹ (STP) and 67 cc g⁻¹ (STP) respectively, while for LMA-2-γ2 it is 128 cc g⁻¹ and 121 cc g⁻¹. Upon exposure to C₂H₂, LMA-1-12 underwent a 3-step transformation with a threshold pressure of 0.01 bar while LMA-2-γ2 exhibited initial loading of 0.5 mmol at 0.02 bar, followed by a second step at 0.03 bar. A comparison of all six isotherms shows that LMA-1-γ2 underwent switching at lower partial pressures than LMA-2-γ2. Furthermore, LMA-1-γ2 exhibited two intermediate phases between closed and open while LMA-2-γ2 did not. Although the LMA-γ2 forms are isostructural, the substitution of fluorine for the hydrogen atom in DPT clearly influenced the sorption properties of the material. The single point pore volumes obtained from these cryogenic sorption experiments correlate well with pore volumes from SCXRD.

High-pressure CO₂ gas sorption experiments were collected at 273 K and 298 K (FIGS. 6B and 6D) and showed good agreement with the cryogenic data, in particular the high-pressure CO₂ isotherm profiles collected at 298 K vs. the C₂H₂ 195 K data. To gain further insight into the nature of the transformations of the LMA-γ2 forms, in situ PXRD experiments at selected pressures were performed. At 7 bar CO₂, the PXRD patterns of both LMA-γ2 forms (FIGS. 6C and 6E) revealed peak shifting to lower 20 values consistent with expansion of the unit cell volume with a phase change occurring at 13 bar for LMA-1. At this pressure, the first PXRD peak had shifted to 2θ=4.75° with additional new peaks occurring at 2θ=6.35°, 7.31°, 9.46°, 10.40° and 19.01°.

The good pore volume agreement of LMA-1-γ2 suggests that this CO₂-loaded phase may be equivalent to LMA-1-β. At 17 bar, a second transformation was observed in LMA-1 with peaks shifting to even lower 20 values. Four prominent peaks were observed at 2θ=4.75°, 6.75°, 9.44° and 10.91°. Unlike LMA-1, LMA-2 did not transform at this pressure. Further loading (35 bar) for LMA-1 showed only minor peak shifting, this phase being similar to LMA-1-α but with CO₂ as the guest. In the case of LMA-2, the PXRD pattern at 35 bar was markedly different to that at 17 bar but matched that of LMA-1. Upon exposure to vacuum, both sorbents reverted to the respective LMA-x-γ2 phases.

Having observed ring-closure in a single crystal of LMA-1, the effect of ring-closure upon the sorption properties of LMA-1-2 was investigated by continuously irradiating a bulk powder sample for six hours. The nature of the sorption and XRD photoirradiation experiments required that the data were collected on LMA-1-γ2 and LMA-1-yl, respectively. An overlay of the PXRD pattern generated from the SCXRD of LMA-1-yl-UV with the experimentally obtained PXRD pattern of LMA-1-γ2-UV obtained using an environment cell is consistent with isostructural but different crystal structures. The previously color-less sample turned dark blue and the PXRD diffractogram showed peak shifting to higher 20 values consistent with contraction of the unit cell volume. New peaks were observed at 2θ=8.79°, 12.60° and 13.81° (FIG. 6C). Progressive loading of this phase with 7, 14 and 21 bar of CO₂ showed no changes in the PXRD pattern. This implies that the ring-closed LMA-1-γ2-UV form is stable and not subject to structural reopening under the pressure range studied.

This assumption was further investigated by reversibly irradiating a bulk sample of LMA-1-72 and collecting cryogenic and high-pressure CO₂ experiments at 195 K and at 298 K. Owing to experimental design limitations (relating to sample type, size and irradiation source availability), the powdered sample had to be continuously irradiated for several days. Depending on the extent of irradiation LMA-1-γ2-UV can reversibly reduce its loading capacity by 30-55%.

With the focus of gaining further insight into why a single atom substitution (from hydrogen to fluorine) creates such a marked difference in sorption properties, a computational study was performed. Periodic density functional theory (DFT) electronic structure minimizations were performed on the experimental crystal structures of LMA-1-α, LMA-1-β, and LMA-2-α desolvated in silico to assess their structural relaxation and intermediates. LMA-1-α was found to smoothly relax to a g-like structure, while LMA-1-β relaxed to a metastable open state, with notable changes to its crystal structure but no collapse. Interestingly LMA-2-α, while crystallographically similar in volume and lattice parameters to LMA-1-α, shares more structural similarities with LMA-1-β and as such, is also stabilized from collapse.

These relaxations illustrate several key points. LMA-1-α's crystal structure has a central DPT linker positioned along the a-axis surrounded by 4 BTCP linkers. Its optimization into a g-like structure results from three cooperative movements: rotation of the DPT linker; extension of two N—Cd bonds and displacement of the fluorinated backbone rings of the BTCP linkers. The empty space on either side of the DPT linker permits facile rotation around its central axis, defined by the Cd-carboxylate bonds on either end. At the onset of rotation, two N—Cd bonds from the terminal ends of BTCP linkers and cadmium nodes extend and shift from their original position, moving closer to the center of the pore. As the pore volume decreases, the terminal phenyl rings rotate towards the perfluorinated backbone on the BTCP linkers. The perfluorinated back-bones shift away from the incoming DPT linker, triggering the collapse into a g-like structure.

Furthermore, both LMA-1-β and LMA-2-α have a central DPT/FDPT linker positioned diagonally across their respective pores along the b-axis. If the 4 BTCP linkers are taken to be the walls of a pore, the central DPT linker in LMA-1-β has its para-hydrogen positioned outside of the pore walls at a distance of 3.91 Å away from the nearest BTCP fluorine. The resulting forces cause the rotation of the DPT linker to turn away from the fluorinated rings until it plateaus at an energy minimum with a position 7.53 Å away from the nearest BTCP fluorine. This motion, along with the lack of empty space, allows a rotation analogous to that present in LMA-1-α. This leads to no extension of the N—Cd bonds and no displacement of the fluorinated rings on the BTCP linkers, resulting in a metastable open state.

LMA-2-α has its central FDPT linker also positioned diagonally but protruding into the pore walls, at a distance of 2.86 Å away from the nearest BTCP fluorine. This restricted pore space prevented large cooperative movements to take place, leaving the structure in an open state with small changes to atom positions after optimization. Although LMA-2-α has been shown to collapse into its g-structure experimentally, it is postulated that this is only possible with external perturbations sufficient to overcome the energetic barrier presented by inherent steric hindrance, such as the movement of guest molecules during desorption.

These results demonstrate a readily accessible energy landscape for different phases of LMA-1 and support the experimentally observed behavior of LMA-1's sorption isotherm being multi-step in contrast to LMA-2. The DPT moiety in LMA-1 allows access to a variety of states from the camouflaged to detectable phase as shown by the relaxation of LMA-1-α. Relaxation of LMA-1-β also showed the presence of metastable states that could correspond to distinct steps on the sorption isotherm. The physically relevant nature of the conformational states was assessed by the simulated excess adsorption isotherms of LMA-1-α and LMA-2-α confirming similar uptake at saturation, and for LMA-1-β, uptake characteristic of a state corresponding to a step in the isotherm.

From this data, it is inferred that fluorination of the DPT linker leads to a more sterically frustrated open phase in LMA-2, with an energy barrier associated with collapse that was not observed from the relaxation calculations of LMA-1. This behavior mirrors the sharp transition from the closed to the open phase shown in LMA-2's single-step sorption isotherm.

In summary, certain embodiments are directed to photosensitive coatings which reversibly switch (closed to open phase transformation) in response to multiple stimuli (i.e. gas/vapor and heat/vacuum) and which have light-responsive components incorporated into the backbone of the PCN, enabling a further ring-open to ring-closed transformation.

### Ligand Synthesis

Commercially available starting materials and solvents were purchased from Sigma Aldrich, Merck and Fluorochem. All reactions were monitored using aluminum backed silica gel Merck 60 F254 TLC plates and visualized using UV irradiation. Column chromatography was carried out with Merck silica gel 230-400 mesh silica gel.

### 1.1 Synthesis of DPT

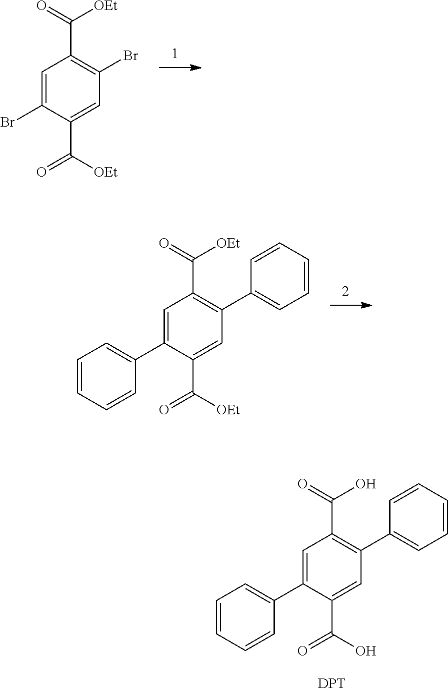

Step 1: A 1:1:1 mixture (total 150 ml) of ethanol, water and toluene was degassed using N₂ for 30 min. Thereafter, diethyl 2,5-dibromoterephthalate (7.5 g, 19.9 mmol, 1.0 eq), phenyl boronic acid (7.22 g, 59.6 mmol, 2.5 eq), Pd(PPh₃)₄ (1.15 g, 5.0 mol %) and Na₂CO₃ (10.55 g, 99.5 mmol, 5.0 equiv) were all added to the solvent mixture under an inert atmosphere. The resulting reaction mixture was heated to reflux under N₂. After 24 h, the mixture was allowed to cool to room temperature. TLC analysis confirmed complete conversion of the starting material, as well as product formation. The contents of the flask were then transferred to a separating funnel using toluene. Additional toluene (100 ml) was added, and the aqueous and organic layers were separated. After drying over MgSO4, the organic layer was concentrated under reduced pressure affording diethyl [1,1′:4′,1″-terphenyl]-2′,5′-dicarboxylate as the crude product. This material was used in the subsequent step without further purification.

Step 2: A 1:1 mixture (total 150 ml) of ethanol and water was added to the crude diethyl [1,1′:4′,1″-terphenyl]-2′,5′-dicarboxylate product. NaOH (20 g, excess) was then added. The resulting reaction mixture was then heated to reflux, which was maintained for 24 h. After cooling to room temperature, the excess ethanol was removed under reduced pressure. The aqueous phase was filtered and carefully acidified using concentrated HCl resulting in the formation of a white precipitate. The white solid was isolated via filtration and washed thoroughly with water. After drying in a 105° C. oven overnight, 5.83 g (18.3 mmol, 92% over two steps) of DPT was isolated as a white solid. 1H NMR (400 MHZ, MeOD) δ 7.76 (s, 2H), 7.45-7.36 (m, 10H) ppm.

### 1.2 Synthesis of FOPT

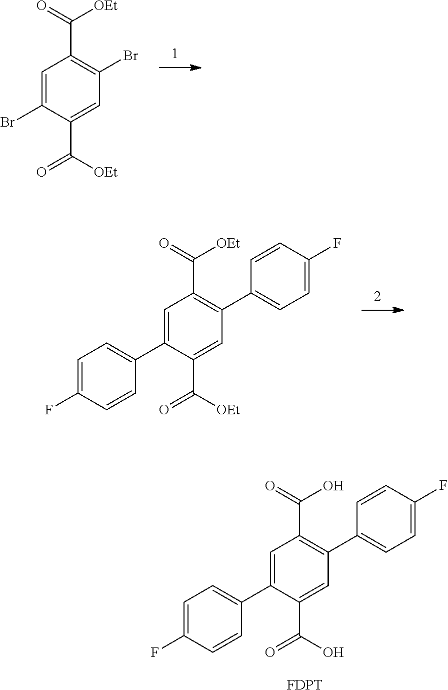

Step 1: A 1:1:1 mixture (total 150 ml) of ethanol, water and toluene was degassed using N₂ for 30 min. Thereafter, diethyl 2,5-dibromoterephthalate (5.0 g, 13.2 mmol, 1.0 eq), (4-fluorophenyl) boronic acid (4.63 g, 33.1 mmol, 2.5 eq), Pd(PPh₃)₄ (0.76 g, 5.0 mol %) and Na₂CO₃ (7.0 g, 66.0 mmol, 5.0 equiv) were all added to the solvent mixture under an inert atmosphere. The resulting reaction mixture was heated to reflux under N₂. After 24 h, the mixture was allowed to cool to room temperature. TLC analysis confirmed complete conversion of the starting material, as well as product formation. The contents of the flask were then transferred to a separating funnel using toluene. Additional toluene (100 ml) was added, and the aqueous and organic layers were separated. After drying over MgSO₄, the organic layer was concentrated under reduced pressure affording diethyl 4,4″-difluoro-[1,1′:4′,1″-terphenyl]-2′,5′-dicarboxylate as the crude product. This material was used in the subsequent step without further purification.

Step 2: A 1:1 mixture (total 150 ml) of ethanol and water was added to the crude diethyl 4,4″-difluoro-[1,1′:4′,1″-terphenyl]-2′,5′-dicarboxylate. NaOH (20 g, excess) was then added. The resulting reaction mixture was then heated to reflux, which was maintained for 24 h. After cooling to room temperature, the excess ethanol was removed under reduced pressure. The aqueous phase was filtered and carefully acidified using concentrated HCl resulting in the formation of a white precipitate. The white solid was isolated via filtration and washed thoroughly with water. After drying in a 105° C. oven overnight, 3.70 g (10.4 mmol, 79% over two steps) of FDPT was isolated as a white solid. 1H NMR (400 MHZ, MeOD) δ 7.77 (s, 2H), 7.37-7.45 (m, 4H), 7.11-7.24 (m, 4H) ppm

BTCP was synthesized according to our previously reported method (Nikolayenko, V. I., Castell, D. C., van Heerden, D., Barbour, L. J., Angew. Chem. Int. Ed. 2018, 57, 12086-12091).

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A photosensitive coating comprising a photosensitive sorbent composition comprising:
a metal;
a photosensitive ligand of the metal, wherein the photosensitive ligand is reversibly transformable between two different molecular structures according to a photochemical transformation; and
a bridging ligand that coordinates two or more metal atoms, and
wherein the photosensitive sorbent composition is configured to reversibly transform from an open phase to a closed phase with a stepped isotherm profile,
wherein the photosensitive sorbent composition transforms from the open phase to the closed phase upon exposure to light of a first wavelength and transforms from the closed phase to the open phase upon exposure to light of a second wavelength,
wherein the photosensitive coating has a greater ability to absorb electromagnetic radiation while the photosensitive sorbent composition is in the open phase than the closed phase.

2. The photosensitive coating of claim 1, wherein the photochemical transformation is a photoisomerization reaction or a photocyclization reaction.

3. The photosensitive coating of claim 2, wherein the photosensitive ligand comprises an azobenzene, a fulgide, a spirobenzopyran, or a dithienylethene.

4. The photosensitive coating of claim 3, wherein the photosensitive ligand comprises a bis-3-thienylcyclopentene.

5. The photosensitive coating of claim 4, wherein the photosensitive ligand is 1,2-bis[2-methyl-5-(4-pyridyl)-3-thienyl]perfluorocyclopentene (BTCP).

6. The photosensitive coating of claim 1, wherein the bridging ligand is a dicarboxylate or N-donor linker.

7. The photosensitive coating of claim 6, wherein the bridging ligand comprises a benzene-1,4-dicarboxylic acid or a pyridine.

8. The photosensitive coating of claim 7, wherein the bridging ligand comprises 2,5-diphenylbenzene-1,4-dicarboxylic acid (DPT) or 2,5-di-(4-fluorophenyl)benzene-1,4-dicarboxylic acid (FDPT).

9. The photosensitive coating of claim 1, wherein the metal is selected from the group consisting of Ag, Ca, K, Zn, Na, Pb, Mn, Fe, Co, Ni, Al, Si, Cu, Sn, Cd, Hg, Cr, Fe, Bi, Ga, Ge, Au, In, Tl, Rb, Cs, As, Sb, Cr, Zn, V, Pt, Pd, and Rh.

10. The photosensitive coating of claim 9, comprising Cd(BTCP)(DPT)₂ or Cd(BTCP)(FDPT)₂.

11. The photosensitive coating of claim 1, wherein the photosensitive coating is configured to transform from the open phase to the closed phase when illuminated with light having a wavelength between about 100-400 nm.

12. The photosensitive coating of claim 1, wherein the photosensitive coating is configured to transform from the closed phase to the open phase when illuminated with light having a wavelength between about 400-800 nm.

13. The photosensitive coating of claim 1, wherein the open phase of the photosensitive coating is characterized by a first color and the closed phase of the photosensitive coating is characterized by a second color different from the first color.

14. The photosensitive coating of claim 1, wherein the photosensitive coating has different spectral characteristics when in the open phase and the closed phase, such that an object coated with the photosensitive coating has a first spectral signature when the photosensitive coating is in the open phase and has a second spectral signature different from the first spectral signature when the photosensitive coating is in the closed phase.

15. The photosensitive coating of claim 14, wherein the object coated with the photosensitive coating has a first radar signature when the photosensitive coating is in the open phase and has a second radar signature when the photosensitive coating is in the closed phase, and the first radar signature is lower than the second radar signature.

16. The photosensitive coating of claim 14, wherein the object coated with the photosensitive coating has a first infrared signature when the photosensitive coating is in the open phase and has a second infrared signature when the photosensitive coating is in the closed phase, and the first infrared signature is lower than the second infrared signature.

17. The photosensitive coating of claim 14, wherein the object coated with the photosensitive coating has a first temperature profile when the photosensitive coating is in the open phase and has a second temperature profile different from the first temperature profile when the photosensitive coating is in the closed phase.

18. (canceled)

19. A method of reversibly camouflaging an object, the method comprising:
(a) coating an object with a photosensitive coating comprising a photosensitive sorbent composition comprising:
a metal;
a photosensitive ligand of the metal, wherein the photosensitive ligand is reversibly transformable between two different molecular structures according to a photochemical transformation; and
a bridging ligand that coordinates two or more metal atoms, and
wherein the photosensitive sorbent composition is configured to reversibly transform from an open phase to a closed phase with a stepped isotherm profile,
wherein the photosensitive sorbent composition transforms from the open phase to the closed phase upon exposure to light of a first wavelength and transforms from the closed phase to the open phase upon exposure to light of a second wavelength,
wherein the photosensitive coating has a greater ability to absorb electromagnetic radiation while the photosensitive sorbent composition is in the open phase than the closed phase;
(b) irradiating light of the first wavelength on the photosensitive coating to transform the photosensitive coating into the closed phase having a first reflectance characteristic; and
(c) irradiating light of the second wavelength on the photosensitive coating to transform the photosensitive coating into the open phase having a second reflectance characteristic that reflects a lesser amount of electromagnetic radiation than the first reflectance characteristic.

20. (canceled)

21. A reversibly camouflaged object, the object comprising a photosensitive coating comprising a photosensitive sorbent composition comprising:
a metal;
a photosensitive ligand of the metal, wherein the photosensitive ligand is reversibly transformable between two different molecular structures according to a photochemical transformation; and
a bridging ligand that coordinates two or more metal atoms, and
wherein the photosensitive sorbent composition is configured to reversibly transform from an open phase to a closed phase with a stepped isotherm profile,
wherein the photosensitive sorbent composition transforms from the open phase to the closed phase upon exposure to light of a first wavelength and transforms from the closed phase to the open phase upon exposure to light of a second wavelength,
wherein the photosensitive coating has a greater ability to absorb electromagnetic radiation while the photosensitive sorbent composition is in the open phase than the closed phase.

22. (canceled)

23. (canceled)

24. A method of validating the authenticity of an object, the method comprising identifying the photosensitive coating of claim 1,
wherein the identification comprises exposing the photosensitive coating to light of the first and/or second wavelength, and
detecting one or more physical characteristics of the photosensitive coating in the open phase and/or the closed phase.
